(19) United States
(12) Patent Application Publication
(10) Pub. No.: US 2007/0262193 A1
(43) Pub. Date: Nov. 15, 2007

(54) Increased crush-resistant core for geomembrane liner roll

(75) Inventor: Edward Hydorn Chapman III, Arlington, TX (US)

Correspondence Address: AKIN GUMP STRAUSS HAUER & FELD, LLP, P O BOX 688, DALLAS, TX, 75313-0688, US

(73) Assignee: Olympic General Corporation, Henderson, NV (US)

(21) Appl. No.: 11/430,608

(22) Filed: May 9, 2006

(51) Int. Cl. B65H 75/18; B29C 65/00

(52) U.S. Cl. 242/609.4; 242/610.6; 156/294

(57) ABSTRACT

An increased crush-resistant core for a geomembrane liner roll includes a tube-shaped exterior section. The exterior section has a selected length and inner and outer diameters defining a channel. The core includes at least two tube-shaped interior sections. Each interior section is installed at a selected location in the channel. The exterior section can be made from paper, card-board or fiber. The interior sections are made from plastic or other suitable material.

This invention relates generally to a core for a geomembrane liner roll, and more particularly to an increased crush-resistant core for a geomembrane liner roll.

### BACKGROUND OF THE INVENTION

Geomembrane liners are widely used in landfills, canals, ponds, construction sites and other areas. For example, geomembrane liners are used in landfills to prevent contamination of ground water or waterways. The liners can be used to line a containment area or to cap a polluted area.

Geomembrane liners are made from polymer or other suitable material. After the liner is formed, it is cut into desired dimensions. For example, a liner can be cut into a 23 feet wide and 1550 feet long sheet. For ease of handling, storage and transportation, the liner is wound on a core thereby forming a geomembrane liner roll. Because of the weight of the material, a geomembrane liner roll can be very heavy. A 23 feet wide and 1550 feet long geomembrane liner roll wound into a roll weighs approximately 4000 lbs.

The core is typically a tube-shaped core made from paper, cardboard, fiber or other suitable material. The core may be formed into a desired dimension suitable to allow a geomembrane liner to be wound on the core. A core, for example, may have a length of approximately 23 feet, a thickness of ½ inch and an inner diameter of 6 inches.

FIG. 1 illustrates a geomembrane liner roll 100. The roll 100 includes a liner 104 wound on a core 108. In FIG. 1, the length of the core 108 is slightly greater than the width of the liner 104 that is wound on the core 108, and consequently, the core 108 extends beyond the ends of the liner 104. However, the length of the core 108 can be less than the width of the liner 104.

FIG. 2 is a photograph of a geomembrane liner roll. As shown in FIG. 2, the geomembrane liner is wound on a core thereby forming the roll. The core shown in FIG. 2 is made from a laminated paper.

After the geomembrane liner rolls are formed, a manufacturer needs to lift and move the rolls. If the liner is placed in temporary storage, the manufacturer later will be required to lift and load the rolls in a vehicle for transportation to the customer site. The customer is then required to unload the rolls and move them to an appropriate location.

Specialized fork lift-type equipment is generally required to lift and move the geomembrane liner rolls. They typically grab a roll by inserting two prongs, one at each end of the core, and lift the core. In order for the roll to be efficiently lifted and moved, the prongs must be quickly inserted into the ends of the core. Thus, the core must retain its structural integrity especially at the ends so that the prongs may be inserted without undue problems.

Manufacturers of geomembrane liner rolls often store the rolls in warehouses or on open lots for a period of time prior to their shipment to customers. Also, customers often leave the geomembrane liner rolls on open lots for a period of time prior to their actual use. Consequently, the rolls are often subjected to various environmental factors such as humidity, moisture, rain or snow. These environmental factors may negatively affect the structural integrity of the core.

Cores made from cardboard, paper or similar material often fail to retain their structural integrity. This occurs especially at the ends. If a core loses its structural integrity, it may become difficult to lift and move the roll. If, for example, the roll becomes delaminated at the ends or is crushed at the ends, it is difficult to insert the prongs to lift and move the roll. Furthermore, it has been observed that the cores often initially become crushed at the ends, and gradually the weakness spreads through the entire length of the core, ultimately causing the entire core to be crushed. If the entire core is crushed, it becomes extremely difficult to insert the prongs to lift and move the roll. Often geomembrane rolls become unusable because the crushed core makes them difficult to be lifted and moved. FIG. 3 is a photograph of a geomembrane liner roll in which the core is crushed and delaminated. As will be understood by those skilled in the art, it will be difficult to efficiently lift and move the roll shown in FIG. 3.

Various attempts have been made to solve the foregoing problems. For example, plastic cores made from standard plastic pipes (e.g., 6″ plastic pipe) have been used as cores for geomembrane liners. While plastic cores generally retain their structural integrity and are less susceptible to crushing, it is significantly more expensive to manufacture plastic cores than it is to manufacture cardboard-type cores. Other attempted solutions include use of core plugs and films but these solutions were proven to be unsatisfactory.

Accordingly, there is a need for a core that retains its structural integrity so that it can be efficiently lifted and moved. There is a need for a core that does not become crushed at the ends. There is a need for a core in which prongs can be inserted quickly so that the roll may be efficiently lifted and moved.

### SUMMARY OF THE INVENTION

An increased crush-resistant core for a geomembrane liner roll includes a tube-shaped exterior section. The exterior section has a selected length and inner and outer diameters defining a channel. The core includes at least two tube-shaped interior sections. Each interior section is installed at a selected location in the channel. The length of the interior section is less than the length of the core. Each interior section has an outer diameter approximately equal to the inner diameter of the exterior section to enable the interior section to fit in the channel and to increase the crush-resistance of the core. The exterior section can be made from paper, card-board or fiber. The interior sections are made from plastic or other suitable material. The interior sections are bonded with, or firmly attached to, the exterior section.

### BRIEF DESCRIPTION OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

FIG. 1 illustrates a geomembrane liner roll.

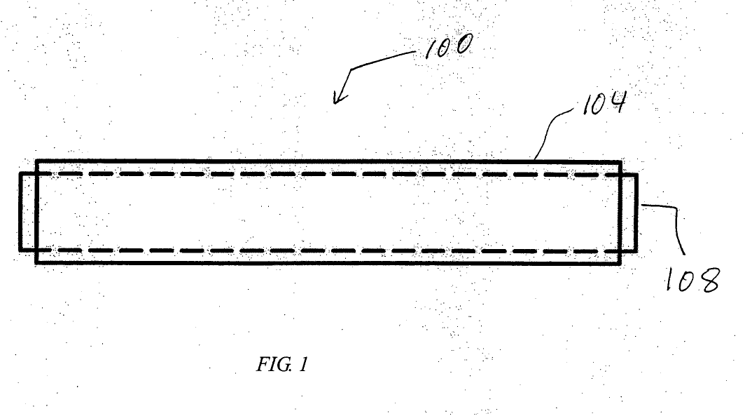

FIG. 2 is a photograph of a geomembrane liner roll.

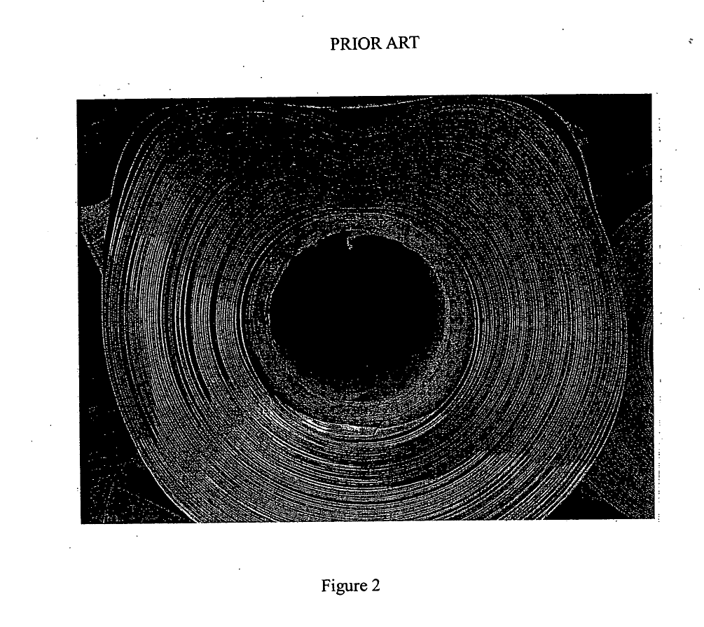

FIG. 3 is a photograph of a geomembrane liner roll in which the core is crushed.

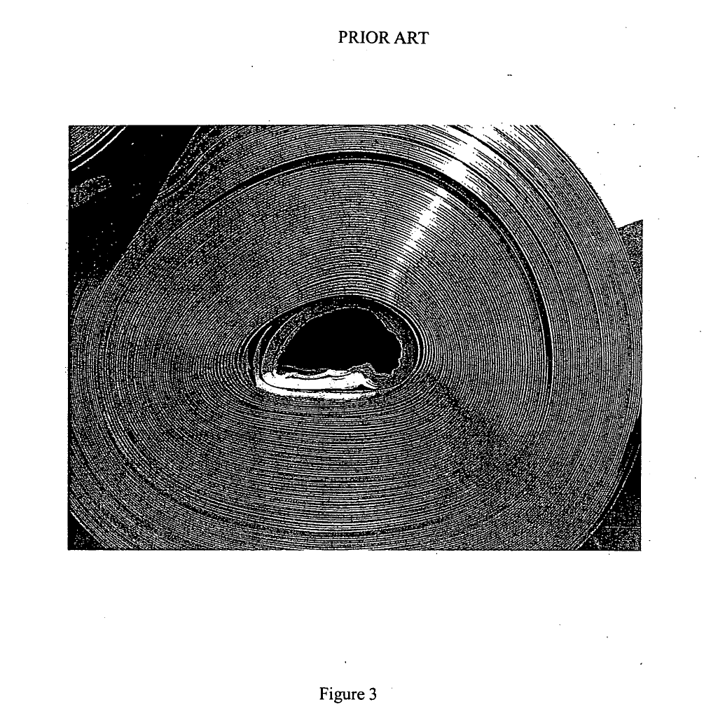

FIG. 4 illustrates an increased crush-resistant core in accordance with one embodiment of the invention.

FIG. 5 shows an interior section of the increased crush-resistant core in accordance with one embodiment of the invention.

FIG. 6 shows a geomembrane liner roll with an increased crush-resistant core.

### DETAILED DESCRIPTION OF THE INVENTION

Various features of the increased crush-resistant core for a geomemrane liner roll will now be described. Those skilled in the art will recognize that the increased crush-resistant core can be used for any other type of liner roll.

Throughout the description, implementation-specific details will be given on how the increased crush-resistant core for a geomembrane liner roll is made. These details are provided to illustrate the preferred embodiments of the invention and not to limit the scope of the invention. The scope of the invention is set in the claims section.

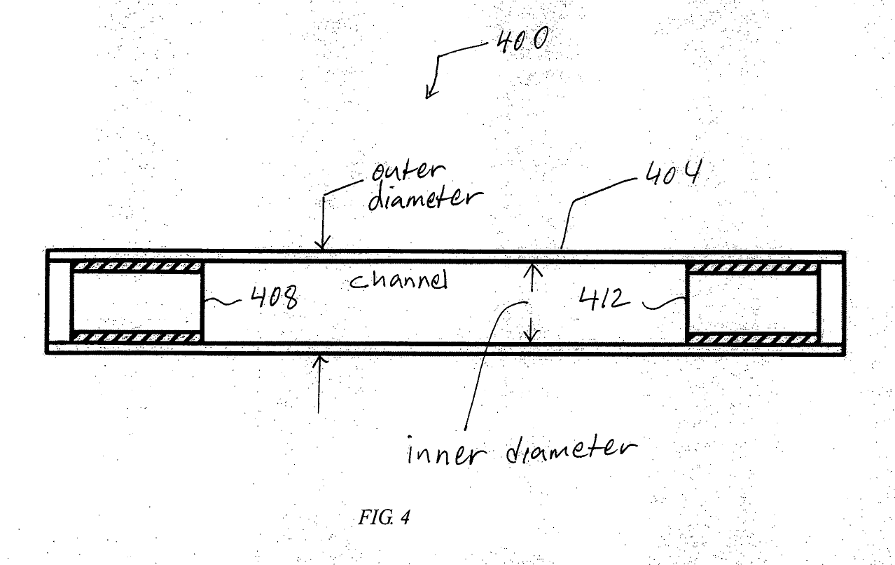

FIG. 4 illustrates an increased crush-resistant core 400 for a geomembrane liner roll in accordance with one embodiment of the invention. The core 400 can be made from cardboard, paper, fiber or other suitable material.

The core 400 has a tube-shaped exterior section 404 having a predetermined length suitable for a geomembrane liner or any other liner to be wound on the core 400. The exterior section 404 has a predetermined thickness formed by the inner and the outer diameter of the exterior section 404. The inner and outer diameters define a channel along the axis of the tube-shaped exterior section 404. For example, the exterior section 404 may have an inner diameter of 5.5 inches and an outer diameter of 6.0 inches. Thus, the exterior section 404 will have a thickness of 0.5 inches. As will be understood by those skilled in the art, the exterior section 404 can have any other desired dimension or shape.

The core 400 further includes two tube-shaped interior sections 408 and 412 configured to be installed inside the exterior section 404. As shown in FIG. 4, the interior sections 408 and 412 are installed in the channel of the exterior section 404. The interior sections 408 and 412 act as sleeves inside the core 400. The sleeves provide radial support to the ends of the exterior section 404 to reinforce the core 400.

In one embodiment, each interior section is installed at one end of the exterior section 404. As discussed before, the interior sections 408 and 412 reinforce the ends of the exterior section 404, thereby preventing the ends from becoming delaminated, crushed or otherwise weakened. As discussed before, the core 400 often initially becomes delaminated or crushed at the ends and the weakness gradually spreads across the length of the core. Thus, by preventing the ends of the core 400 from becoming weakened or crushed, the structural integrity of the entire core 400 can be preserved. While in FIG. 4, only two interior sections 408 and 412 are shown inserted inside the channel, additional tubes may be inserted as well.

The interior sections 408 and 412 can have any desired length. In one example embodiment, two 36-inch interior sections are fitted inside a core having a length of 270 inches. In FIG. 4, the interior sections 408 and 412 are placed completely inside the channel of the exterior section 404. As will be understood by those skilled in the art, the interior sections 408 and 412 may each be only partially inserted into the channel so that a portion of the tubes 404 and 408 may 25 remain outside the channel of the core 400.

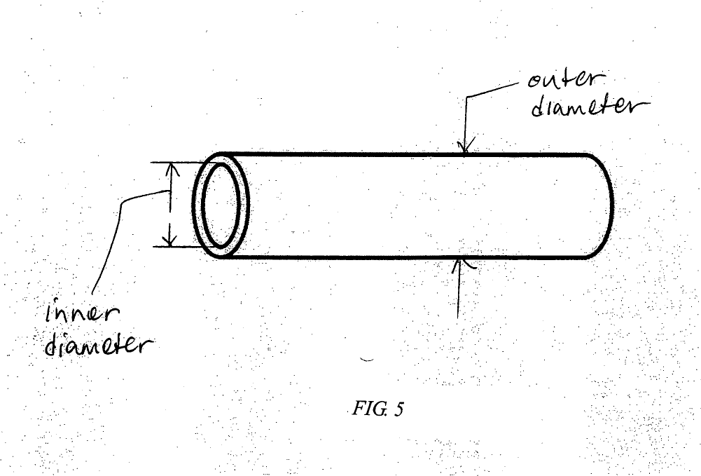

FIG. 5 shows an interior section 408 or 412. The interior section 408 or 412 is tube-shaped, having a predetermined length, and inner and outer diameters defining a channel along the axis. The outer diameter of the interior sections 408 and 412 are substantially equal to the inner diameter of the exterior section 404 so that the interior sections 408 and 412 can fit tightly inside the exterior section 404. The interior sections 408 and 412 are made from plastic, although the interior sections 408 and 412 may be made from other suitable materials as will be obvious to those skilled in the art. The interior sections 408 and 412 can be attached or bonded to the core 400 using adhesives or other well known methods.

The interior sections 408 and 412 reinforce the ends of the core 400, which increase the crush-resistance of the core 400. Experimental results have shown that when plastic-type interior sections are inserted inside a paper-type core, the crush resistance of the core is significantly increased.

The interior sections 408 and 412 reduces the likelihood of the ends of the core 400 from becoming crushed, thus reducing the likelihood of the entire core 400 from eventually becoming crushed. Thus, the geomembrane rolls can be efficiently lifted and moved by inserting prongs at the ends of the core.

Furthermore, by acting as sleeves, the interior sections 408 and 412 reduce the likelihood of the core 400 being damaged by the prongs. Since the interior sections 408 and 412 receive the prongs during lifting and moving, the interior sections 408 and 412 protect the core from being damaged by the prongs. Thus, in addition to increasing the crush-resistance of the core, the interior sections 408 and 412 reduces the likelihood that the core 400 will be damaged when it is lifted or moved with prongs.

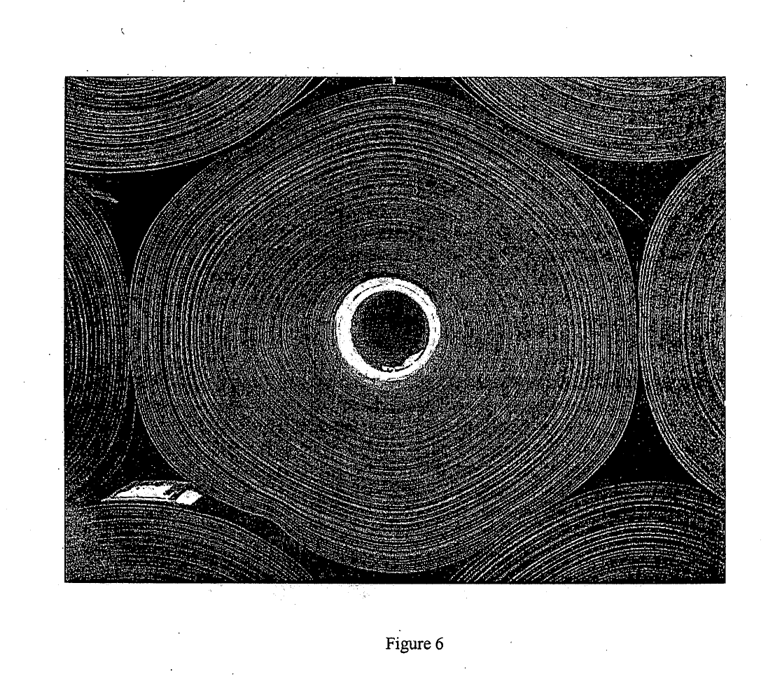

FIG. 6 is a photograph of one end of a geomembrane liner roll. The geomembrane liner is wound on an increased crush-resistant core. As can be seen in FIG. 5, the increased crush-resistant core includes an interior section installed at the end of the core.

The use of the interior sections 408 and 412 to reduce the likelihood of the core 400 becoming crushed is an economically viable solution. The interior sections 408 and 412 can be manufactured inexpensively using plastic, PVC or other suitable materials. The interior sections 408 and 412 can be easily inserted inside the exterior section 404 and attached or bonded to the exterior section 404. Thus, the invention provides an economically viable solution to the problems of the core becoming crushed. The invention reduces the likelihood that the geomembrane rolls will be discarded because of crushed cores.

It will be appreciated by those skilled in the art that changes could be made to the embodiments described above without departing from the broad inventive concept thereof. While the increased crush-resistant core is shown in connection with geomembrane liner rolls, it will be understood by those skilled in the art that the increased crush-resistant core can be used in other types of liners. It is understood, therefore, that this invention is not limited to the particular embodiments disclosed, but it is intended to cover modifications within the spirit and scope of the present invention as defined by the appended claims.

1. An increased crush-resistant core for a geomembrane liner roll, comprising:
a tube-shaped exterior section having a selected length and inner and outer diameters defining a channel; and
at least two tube-shaped interior sections each installed at a selected location in the channel, the length of the interior sections being less than the length of the core, each interior section having an outer diameter approximately equal to the inner diameter of the exterior section to enable the interior section to fit in the channel and to increase the crush-resistance of the core.

2. The increased crush-resistant core of claim 1, wherein the exterior section is made from paper.

3. The increased crush-resistant core of claim 1, wherein the exterior section is made from card-board.

4. The increased crush-resistant core of claim 1, wherein the exterior section is made from a fiber.

5. The increased crush-resistant core of claim 1, wherein the interior sections are made from plastic.

6. The increased crush-resistant core of claim 1, wherein the geomembrane liner comprises one or more polymer liners.

7. The increased crush-resistant core of claim 1, wherein the geomembrane liner is a layered geosystem.

8. The increased crush-resistant core of claim 1, wherein the interior sections are bonded with the exterior section.

9. The increased crush-resistant core of claim 1, wherein the interior sections are firmly attached to the exterior section.

10. The increased crush-resistant core of claim 1, wherein the interior sections are attached to the exterior section by an adhesive.

11. The increased crush-resistant core of claim 1, wherein the interior sections are installed at each end of the channel.

12. An increased crush-resistant core for a polymer liner roll, comprising:
a tube-shaped exterior section having a selected length and inner and outer diameters defining a channel; and
at least two tube-shaped interior sections each at least partially inserted into the channel, the length of the interior sections being less than the length of the exterior section, each interior section having a predetermined outer diameter to enable the interior section to fit in the channel and provide radial support to the exterior section to increase the crush-resistance of the core.

13. The increased crush-resistant core of claim 12, wherein the interior sections are inserted completely inside the channel.

14. The increased crush-resistant core of claim 12, wherein the interior sections are made from plastic.

15. The increased crush-resistant core of claim 12, wherein the polymer liner is a geomembrane liner.

16. The increased crush-resistant core of claim 12, wherein the polymer liner is a layered geosystem.

17. The increased crush-resistant core of claim 12, wherein the interior sections are bonded with the exterior sections.

18. The increased crush-resistant core of claim 12, wherein the interior sections are firmly attached to the exterior section.

19. The increased crush-resistant core of claim 12, wherein the interior sections are attached to the exterior section by an adhesive.

20. The increased crush-resistant core of claim 12, wherein the interior sections are installed at each end of the channel.

21. A polymer liner roll, comprising:
a tube-shaped exterior section having a selected length and inner and outer diameters defining a channel; and
at least two tube-shaped interior sections each at least partially inserted into the channel, the length of the interior sections being less than the length of the core, each interior section having a predetermined outer diameter to enable the interior section to fit in the channel to increase the crush-resistance of the core,
wherein the polymer liner is wound on the core to form the roll.

22. A method of making a crush-resistant core for a liner roll, comprising the steps of:
making a tube-shaped exterior section having a predetermined length and inner and outer diameters defining a channel; and
inserting at least two tube-shaped interior sections at selected locations inside the channel to increase the crush-resistance of the core.

23. The method of claim 22, wherein each interior section has a predetermined outer diameter to enable the interior section to fit in the channel to provide radial support to the core.

24. The method of claim 22, wherein the interior sections are made from plastic.

25. The method of claim 22, further comprising the step of bonding the interior sections with the exterior section.

26. The method of claim 22, further comprising the step of attaching the interior sections to the exterior section by an adhesive.

27. The method of claim 22, wherein the liner is a polymer liner.

28. The method of claim 22, wherein the liner is geomembrane liner.
